(19) United States
(12) Patent Application Publication
(10) Pub. No.: US 2024/0023205 A1
(43) Pub. Date: Jan. 18, 2024

(54) WIRING SHEET AND WIRING SHEET PRODUCTION METHOD

(71) Applicant: LINTEC CORPORATION, Tokyo (JP)

(72) Inventors: Takashi MORIOKA, Itabashi-ku, Tokyo (JP); Yuma KATSUTA, Itabashi-ku, Tokyo (JP); Masaharu ITO, Itabashi-ku, Tokyo (JP)

(21) Appl. No.: 18/028,487

(22) PCT Filed: Mar. 31, 2021
(86) PCT No.: PCT/JP2021/013791

§ 371 Date: Oct. 4, 2023

(30) Foreign Application Priority Data
Sep. 30, 2020 (JP) 2020-165140

(51) Int. Cl. H05B 3/34; H01R 11/01; H05B 3/03; H05B 3/06; H05B 3/14; H05B 3/36

(52) U.S. Cl. CPC H05B 3/347; H01R 11/01; H05B 3/03; H05B 3/06; H05B 3/145; H05B 3/345; H05B 3/36; H05B 2203/014; H05B 2203/017; H05B 2214/04

(57) ABSTRACT

A wiring sheet includes a pair of electrodes and a pseudo sheet structure including a plurality of conductive linear bodies arranged at intervals, in which the pseudo sheet structure is electrically connected to the electrodes, and the conductive linear bodies and the electrodes are fixed with contact fixing members.

### TECHNICAL FIELD

The present invention relates to a wiring sheet and a method of producing the wiring sheet.

### TECHNICAL FIELD

A sheet-shaped conductive member (hereinafter also referred to as a “conductive sheet”), which includes a pseudo sheet structure in which a plurality of conductive linear bodies are arranged at intervals, may be used as a component of various articles (e.g., a heat-generating body of a heater, a material of heat-generating textiles, and a protection film (anti-shattering film) for a display device).

Patent Literature 1 discloses an example of a sheet usable for a heat-generating body in a form of a conductive sheet including a pseudo sheet structure in which a plurality of linear bodies extending unidirectionally are arranged at intervals. A pair of electrodes is provided at respective ends of the plurality of linear bodies to provide a wiring sheet usable as a heat-generating body.

### CITATION LIST

### Patent Literature(s)

Patent Literature 1: WO 2017/086395 A

### SUMMARY OF THE INVENTION

### Problems(s) to be Solved by the Invention

However, it is found out that the wiring sheet as described in Patent Literature 1 may have a high resistance value of wirings. When the electrodes are firmly fixed to the linear bodies by a resin layer or the like, the wiring sheet has difficulty in stretching in an axial direction of the electrodes.

An object of the invention is to provide a wiring sheet capable of stabilizing a resistance value of wirings and having stretchability in an axial direction of electrodes, and a method of producing the wiring sheet.

### Means for Solving the Problem(s)

According to an aspect of the invention, there is provided a wiring sheet, including: a pseudo sheet structure including a plurality of conductive linear bodies arranged at intervals; and a pair of electrodes, in which the pseudo sheet structure is electrically connected to the electrodes, and the conductive linear bodies and the electrodes are fixed with contact fixing members.

In the wiring sheet according to the aspect of the invention, the contact fixing members are preferably each independently arranged in a cross-sectional view of the wiring sheet.

In the wiring sheet according to the aspect of the invention, the electrodes are preferably a metal wire.

In the wiring sheet according to the aspect of the invention, the contact fixing members are preferably at least one selected from the group consisting of a metal, an adhesive agent, and crimping.

In the wiring sheet according to the aspect of the invention, an elastic modulus at 25 degrees C. of the contact fixing members is preferably 5.0×10⁸ Pa or more.

In the wiring sheet according to the aspect of the invention, the conductive linear bodies and the electrodes are preferably wavy-shaped in a plan view of the wiring sheet.

Preferably, the wiring sheet according to the aspect of the invention further includes a stretchable resin layer that supports the pseudo sheet structure.

Preferably, the wiring sheet according to the aspect of the invention further includes a stretchable base material that supports the pseudo sheet structure.

In the wiring sheet according to the aspect of the invention, preferably, the contact fixing members are at least in a form of a solidified product of a molten resin of the base material.

According to an aspect of the invention, there is provided a method of producing the wiring sheet, in which the contact fixing members are formed by at least one method selected from the group consisting of hot press, high-frequency welding, hot-air welding, hot-plate welding, and ultrasonic welding.

According to the aspects of the invention, a wiring sheet capable of stabilizing a resistance value of wirings and having stretchability in an axial direction of electrodes and a method of producing the wiring sheet can be provided.

### BRIEF EXPLANATION OF DRAWINGS

FIG. 1 schematically shows a wiring sheet according to a first exemplary embodiment of the invention.

FIG. 2 is a cross-sectional view taken along a line II-II in FIG. 1.

FIG. 3A is a diagram for illustrating a method of producing the wiring sheet according to the first exemplary embodiment of the invention.

FIG. 3B is another diagram for illustrating the method of producing the wiring sheet according to the first exemplary embodiment of the invention.

FIG. 3C is still another diagram for illustrating the method of producing the wiring sheet according to the first exemplary embodiment of the invention.

FIG. 3D is a further diagram for illustrating the method of producing the wiring sheet according to the first exemplary embodiment of the invention.

FIG. 4A is a diagram for illustrating a method of producing a wiring sheet according to a second exemplary embodiment of the invention.

FIG. 4B is another diagram for illustrating the method of producing the wiring sheet according to the second exemplary embodiment of the invention.

FIG. 4C is still another diagram for illustrating the method of producing the wiring sheet according to the second exemplary embodiment of the invention.

FIG. 4D is a further diagram for illustrating the method of producing the wiring sheet according to the second exemplary embodiment of the invention.

### DESCRIPTION OF EMBODIMENT(S)

### First Exemplary Embodiment

Exemplary embodiment(s) of the invention will be described below with reference to the attached drawings. The scope of the invention is not limited to the disclosures of the exemplary embodiment(s). It should be noted that some parts of the drawings are enlarged or reduced in size for the convenience of description.

### Wiring Sheet

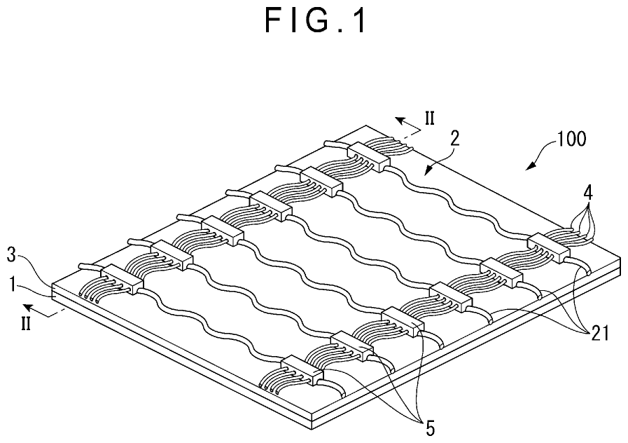

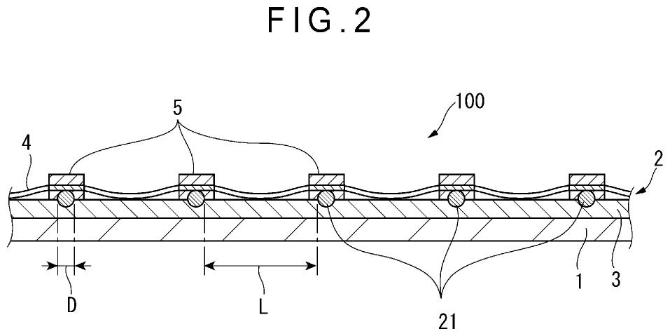

As shown in FIGS. 1 and 2, a wiring sheet 100 according to the exemplary embodiment includes a pseudo sheet structure 2 and a pair of electrodes 4. The pseudo sheet structure 2 is electrically connected to the electrodes 4. The conductive linear bodies 21 and the electrodes 4 are fixed with contact fixing members 5 at respective connection portions.

Since the conductive linear bodies 21 and the electrodes 4 are fixed with the contact fixing members 5, the electrodes 4 are prevented from separating from the pseudo sheet structure 2. Accordingly, the electrical connection between the electrodes 4 and the pseudo sheet structure 2 is stably provided, stabilizing a resistance value of wirings. As shown in FIG. 1, the contact fixing members 5 are each independently arranged in a cross-sectional view of the wiring sheet 100. Thus, when the wiring sheet 100 stretches in an axial direction of the electrodes 4, the contact fixing members 5 do not interfere with the stretching of the wiring sheet 100. Accordingly, the stretchability of the wiring sheet 100 in the axial direction of the electrodes 4 can be provided.

### Base Material

The base material 1 can support the pseudo sheet structure 2 directly or indirectly. Examples of the base material 1 include a synthetic resin film, paper, metallic foil, nonwoven fabric, fabric, and glass film. The base material 1 is preferably a stretchable base material. The stretchable base material 1 can provide stretchability of the wiring sheet 100 even when the pseudo sheet structure 2 is disposed on the base material 1.

Examples of the stretchable base material include a synthetic resin film, nonwoven fabric, and fabric.

Examples of the synthetic resin film include a polyethylene film, polypropylene film, polybutene film, polybutadiene film, polymethylpentene film, polyvinyl chloride film, vinyl chloride copolymer film, polyethylene terephthalate film, polyethylene naphthalate film, polybutylene terephthalate film, polyurethane film, ethylene vinyl acetate copolymer film, ionomer resin film, ethylene-(meth)acrylate copolymer film, ethylene-(meth)acrylate ester copolymer film, polystyrene film, polycarbonate film, and polyimide film. Other examples of the stretchable base material include cross-linked films and laminate films of the above materials.

Examples of the nonwoven fabric include spun-bond nonwoven fabric, needle-punched nonwoven fabric, melt-blown nonwoven fabric, and spunlace nonwoven fabric. Examples of the fabric include woven fabric and knit fabric. Note that the paper, nonwoven fabric, and fabric exemplified as the stretchable base material are not limited to the above.

The thickness of the stretchable base material is not particularly limited. The thickness of the stretchable base material is preferably in a range from 10 μm to 10 mm, more preferably in a range from 15 μm to 3 mm, and still more preferably in a range from 50 μm to 1.5 mm.

### Pseudo Sheet Structure

The pseudo sheet structure 2 is configured to include the conductive linear bodies 21 arranged at intervals. Specifically, in the pseudo sheet structure 2, the conductive linear bodies 21 are arranged at intervals so as to form a flat or curved surface. The conductive linear bodies 21 extending unidirectionally are linear-shaped or wavy-shaped in a plan view of the wiring sheet 100. In the pseudo sheet structure 2, the conductive linear bodies 21 are arranged in a direction orthogonal to an axial direction of the conductive linear bodies 21.

The conductive linear bodies 21 are preferably wavy-shaped in a plan view of the wiring sheet 100. Examples of the wavy shape include a sine-wave, rectangular wave, triangular wave, and saw-tooth wave. The pseudo sheet structure 2 of such an arrangement can restrain breakage of the conductive linear bodies 21 when the wiring sheet 100 is stretched in the axial direction of the conductive linear bodies 21.

A volume resistivity of the conductive linear body 21 is preferably in a range from 1.0×10⁻⁹ Ω·m to 1.0×10⁻³ Ω·m, more preferably in a range from 1.0×10⁻⁸ Ω·m to 1.0×10⁻⁴ Ω·m. Surface resistance of the pseudo sheet structure 2 is easily lowered when the volume resistivity of the conductive linear body 21 is within the above range.

The volume resistivity of the conductive linear body 21 is measured as follows. A silver paste is applied to both ends of the conductive linear body 21 and a resistance of a portion at a length of 40 mm from each end is measured to calculate a resistance value of the conductive linear body 21. Then, a value, which is obtained by multiplying a cross-sectional area (unit: m²) of the conductive linear body 21 by the above resistance value, is divided by the above measured length (0.04 m) to calculate the volume resistivity of the conductive linear body 21.

The cross-sectional shape of the conductive linear body 21, which is not particularly limited, may be polygonal, flattened, elliptical, or circular. An elliptical shape or a circular shape is preferable in view of compatibility with the resin layer 3.

When the cross section of the conductive linear body 21 is circular, a thickness (diameter) D of the conductive linear body 21 (see FIG. 2) is preferably in a range from 5 μm to 75 μm. In order to restrain an increase in sheet resistance and improve heat generation efficiency and anti-insulation/breakdown properties when the wiring sheet 100 is used as a heat-generating body, the diameter D of the conductive linear body 21 is more preferably in a range from 8 μm to 60 μm, and still more preferably in a range from 12 μm to 40 μm.

When the cross section of the conductive linear body 21 is elliptical, it is preferable that the major axis thereof is in the same range as the diameter D described above.

The diameter D of the conductive linear body 21 is an average of diameters measured at randomly selected five points of the conductive linear bodies 21 of the pseudo sheet structure 2 through an observation using a digital microscope.

An interval L between the conductive linear bodies 21 (see FIG. 2) is preferably in a range from 0.3 mm to 50 mm, more preferably in a range from 0.5 mm to 30 mm, and still more preferably in a range from 0.8 mm to 20 mm.

When the interval between the conductive linear bodies 21 falls within the above range, the conductive linear bodies are densely arrayed to some extent. This can enhance the performance of the wiring sheet 100 such as keeping the resistance of the pseudo sheet structure at a low level and providing uniform distribution in temperature rise when the wiring sheet 100 is used as a heat-generating body.

The interval L between the conductive linear bodies 21 is obtained by measuring an interval between two adjacent conductive linear bodies 21 of the pseudo sheet structure 2 through observation with a digital microscope.

It should be noted that the interval between adjacent two of the conductive linear bodies 21 herein refers to a length between facing parts of the two conductive linear bodies 21 in an arraying direction of the conductive linear bodies 21 (see FIG. 2). When the conductive linear bodies 21 are arrayed at uneven intervals, the interval L is an average of all intervals between adjacent ones of the conductive linear bodies 21.

The conductive linear body 21, of which structure is not specifically limited, may be a linear body including a metal wire (hereinafter also referred to as a “metal wire linear body”). The metal wire is excellent in heat conductivity, electrical conductivity, handleability, and versatility. The use of the metal wire linear body as the conductive linear body 21 facilitates the improvement in light transmissivity while reducing the resistance value of the pseudo sheet structure 2. Further, when the wiring sheet 100 (pseudo sheet structure 2) is used as a heat-generating body, heat is easily and quickly generated. Furthermore, a small-diameter linear body as described above is easily obtainable.

It should be noted that examples of the conductive linear body 21 include, in addition to the metal wire linear body, a linear body including a carbon nanotube and a linear body in a form of a conductively coated yarn.

The metal wire linear body may be a linear body made of a single metal wire or a linear body provided by spinning a plurality of metal wires.

Examples of the metal wire include wires containing metals, such as copper, aluminum, tungsten, iron, molybdenum, nickel, titanium, silver, and gold, or alloys containing two or more metals (e.g., steels such as stainless steel and carbon steel, brass, phosphor bronze, zirconium-copper alloy, beryllium copper, iron nickel, Nichrome®, nickel titanium, KANTHAL®, HASTELLOY®, and rhenium tungsten). The metal wire may be plated with tin, zinc, silver, nickel, chromium, nickel-chromium alloy, solder, or the like. The surface of the metal wire may be coated with a later-described carbon material or a polymer. Especially, a wire containing at least one metal selected from tungsten, molybdenum, and an alloy containing tungsten and/or molybdenum is thin and high in strength. Thus, such a wire is preferably used in terms of providing the conductive linear bodies 21 with a low volume resistivity.

The metal wire may be coated with a carbon material. Coating the metal wire with a carbon material reduces metallic luster, making it easy for the metal wire to be less noticeable. Further, the metal wire coated with a carbon material is restrained from metal corrosion.

Examples of the carbon material usable for coating the metal wire include amorphous carbon (e.g., carbon black, active carbon, hard carbon, soft carbon, mesoporous carbon, and carbon fiber), graphite, fullerene, graphene, and a carbon nanotube.

The linear body including a carbon nanotube is obtained by, for instance, drawing, from an end of a carbon nanotube forest (which is a grown form provided by causing a plurality of carbon nanotubes to grow on a substrate, being oriented in a vertical direction relative to the substrate, and is also referred to as “array”), the carbon nanotubes into a sheet form, and spinning a bundle of the carbon nanotubes after drawn carbon nanotube sheets are bundled. When the carbon nanotubes are not spun, a ribbon-shaped carbon nanotube linear body is obtained. When the carbon nanotubes are spun, a yarn-shaped linear body is obtained. The ribbon-shaped carbon nanotube linear body is a linear body without a structure in which the carbon nanotubes are twisted. Alternatively, the carbon nanotube linear body can be obtained by performing, for instance, spinning from a dispersion liquid of carbon nanotubes. The production of the carbon nanotube linear body by spinning can be performed, for instance, by a method disclosed in U.S. Patent Application Publication No. 2013/0251619 (JP 2012-126635 A). In order to obtain carbon nanotube linear bodies having a uniform diameter, the yarn-shaped carbon nanotube linear body is preferably used. In order to obtain carbon nanotube linear bodies with high purity, the yarn-shaped carbon nanotube linear body is preferably produced by spinning the carbon nanotube sheets. The carbon nanotube linear body may be a linear body provided by knitting two or more carbon nanotube linear bodies. Alternatively, the carbon nanotube linear body may be a linear body provided by combining a carbon nanotube and another conductive material (hereinafter also referred to as “composite linear body”).

Examples of the composite linear body include: (1) a composite linear body obtained by depositing an elemental metal or metal alloy on a surface of a forest, sheets or a bundle of carbon nanotubes, or a surface of a spun linear body through a method such as vapor deposition, ion plating, sputtering or wet plating in the process of producing a carbon nanotube linear body in which carbon nanotubes are drawn from an end of the carbon nanotube forest to form sheets, the drawn carbon nanotube sheets are bundled, and then the bundle of the carbon nanotubes is spun; (2) a composite linear body in which a bundle of carbon nanotubes is spun with a linear body of an elemental metal, a linear body of a metal alloy, or a composite linear body; and (3) a composite linear body in which a carbon nanotube linear body or a composite linear body is woven with a linear body of an elemental metal, a linear body of a metal alloy, or a composite linear body. In the composite linear body of (2), metal may be supported on the carbon nanotubes when spinning the bundle of the carbon nanotubes as in the composite linear body of (1). Further, although the composite linear body of (3) is a composite linear body provided by weaving two linear bodies, the composite linear body of (3) may be provided by weaving three or more carbon nanotube linear bodies, linear bodies of an elemental metal, linear bodies of a metal alloy, or composite linear bodies, as long as at least one of a linear body of an elemental metal, a linear body of a metal alloy, or a composite linear body is contained.

Examples of the metal for the composite linear body include elemental metals such as gold, silver, copper, iron, aluminum, nickel, chromium, tin, and zinc and alloys containing at least one of these elemental metals (e.g., a copper-nickel-phosphorus alloy, a copper-iron-phosphorus-zinc alloy).

The conductive linear body 21 may be a linear body in a form of a conductively coated yarn. Examples of the yarn include yarns made by spinning from resins such as nylon and polyester. Examples of the conductive coating include coating films of a metal, a conductive polymer, and a carbon material. The conductive coating can be formed by plating, vapor deposition, or the like. The linear body in a form of a conductively coated yarn can be improved in conductivity of the linear body with flexibility of the yarn maintained. In other words, a reduction in resistance of the pseudo sheet structure 2 is facilitated.

### Resin Layer

The resin layer 3 is a layer containing a resin. The resin layer 3 can support the pseudo sheet structure 2 directly or indirectly. The resin layer 3 is preferably a layer containing an adhesive agent. The adhesive agent enables the conductive linear bodies 21 to be easily attached to the resin layer 3 when the pseudo sheet structure 2 is formed on the resin layer 3. The resin layer 3 preferably has stretchability. The stretchable resin layer 3 can provide the stretchability of the wiring sheet 100.

The resin layer 3 may be a layer made from a resin capable of being dried or cured. A hardness sufficient for protecting the pseudo sheet structure 2 is thus imparted to the resin layer 3, allowing the resin layer 3 to also function as a protection film. Further, the cured or dried resin layer 3 exhibits impact resistance, inhibiting the deformation of the resin layer 3 due to impact.

In terms of an easy curability in a short time, the resin layer 3 is preferably curable with an energy ray such as an ultraviolet ray, visible energy ray, infrared ray, or electron ray. It should be noted that “curing with an energy ray” includes thermosetting by energy-ray heating.

Examples of the adhesive agent in the resin layer 3 include: a thermosetting adhesive agent that is curable by heat; a so-called heat-seal adhesive agent that is bondable by heat; and an adhesive agent that exhibits stickiness when wetted. However, in terms of easy application, the resin layer 3 is preferably energy-ray-curable. An energy-ray-curable resin is exemplified by a compound having at least one polymerizable double bond in a molecule, preferably an acrylate compound having a (meth)acryloyl group.

Examples of the acrylate compound include: chain aliphatic skeleton-containing (meth)acrylates (e.g., trimethylol propane tri(meth)acrylate, tetramethylol methanetetra(meth)acrylate, pentaerythritol tri(meth)acrylate, pentaerythritol tetra(meth)acrylate, dipentaerythritol monohydroxy penta(meth)acrylate, dipentaerythritol hexa(meth)acrylate, 1,4-butylene glycol di(meth)acrylate, and 1,6-hexanediol di(meth)acrylate); cyclic aliphatic skeleton-containing (meth)acrylates (e.g., dicyclopentanyl di(meth)acrylate and dicyclopentadiene di(meth)acrylate); polyalkylene glycol(meth)acrylates (e.g., polyethyleneglycol di(meth)acrylate); oligoester (meth)acrylate; urethane (meth)acrylate oligomer; epoxy-modified (meth)acrylate; polyether (meth)acrylates other than the above polyalkylene glycol (meth)acrylates; and itaconic acid oligomer.

A weight average molecular weight (Mw) of the energy-ray-curable resin is preferably in a range from 100 to 30,000, more preferably in a range from 300 to 10,000.

Only one kind or two or more kinds of the energy-ray-curable resins may be contained in the adhesive agent composition. In a case where two or more kinds of the energy-ray-curable resins are contained, a combination and ratio of the energy-ray-curable resins can be selected as needed. In addition, the energy-ray-curable resin may be combined with a later-described thermoplastic resin. A combination and ratio of the energy-ray-curable resin and the thermoplastic resin can be determined as needed.

The resin layer 3 may be a sticky agent layer formed from a sticky agent (a pressure-sensitive adhesive agent). The sticky agent in the sticky agent layer is not particularly limited. Examples of the sticky agent include an acrylic sticky agent, a urethane sticky agent, a rubber sticky agent, a polyester sticky agent, a silicone sticky agent, and a polyvinyl ether sticky agent. Among the above, the sticky agent is preferably at least one selected from the group consisting of an acrylic sticky agent, urethane sticky agent, and rubber sticky agent, more preferably an acrylic sticky agent.

Examples of the acrylic sticky agent include a polymer including a constituent unit derived from alkyl (meth)acrylate having a linear alkyl group or a branched alkyl group (i.e., a polymer with at least alkyl (meth)acrylate polymerized) and an acrylic polymer including a constituent unit derived from (meth)acrylate with a ring structure (i.e., a polymer with at least (meth)acrylate with a ring structure polymerized). Herein, the “(meth)acrylate” is used as a term referring to both “acrylate” and “methacrylate”, and the same applies to other similar terms.

The acrylic copolymer may be cross-linked by a cross-linker. Examples of the cross-linker include a known epoxy cross-linker, isocyanate cross-linker, aziridine cross-linker, and metal chelate cross-linker. In cross-linking the acrylic copolymer, a hydroxyl group, a carboxyl group, or the like, which is reactive with the above cross-linkers, can be introduced into the acrylic copolymer as a functional group derived from a monomer component of the acrylic copolymer.

When the resin layer 3 is formed from a sticky agent, the resin layer 3 may further contain the above-described energy-ray-curable resin in addition to the sticky agent. When the acrylic sticky agent is used as the sticky agent, a compound having a functional group reactive with the functional group derived from a monomer component of the acrylic copolymer and an energy-ray polymerizable functional group in one molecule may be used as the energy-ray-curable component. Reaction between the functional group of the compound and the functional group derived from the monomer component of the acrylic copolymer enables a side chain of the acrylic copolymer to be polymerized by energy ray irradiation. Even when the sticky agent is not an acrylic sticky agent, the polymer component other than the acrylic polymer may be a component whose side chain is energy-ray polymerizable.

The thermosetting resin used in the resin layer 3 is not particularly limited. Specific examples of the thermosetting resin include an epoxy resin, phenol resin, melamine resin, urea resin, polyester resin, urethane resin, acrylic resin, benzoxazine resin, phenoxy resin, amine compound and acid anhydride compound. One of the thermosetting resins may be used alone, or two or more thereof may be used in combination. Among the above examples, in terms of suitability for curing with an imidazole curing catalyst, it is preferable to use an epoxy resin, phenol resin, melamine resin, urea resin, amine compound and acid anhydride compound. Particularly in terms of exhibiting an excellent curability, it is preferable to use an epoxy resin, phenol resin, a mixture thereof, or a mixture of an epoxy resin and at least one selected from the group consisting of a phenol resin, melamine resin, urea resin, amine compound and acid anhydride compound.

A moisture-curable resin used in the resin layer 3 is not particularly limited. Examples of the moisture-curable resin include a urethane resin, which is a resin where an isocyanate group is generated by moisture, and a modified silicone resin.

When the energy-ray-curable resin or the thermosetting resin is used, a photopolymerization initiator, thermal polymerization initiator, or the like is preferably used. A cross-linking structure is formed by using the photopolymerization initiator, thermal polymerization initiator, or the like, making it possible to more firmly protect the pseudo sheet structure 2.

Examples of the photopolymerization initiator include benzophenone, acetophenone, benzoin, benzoinmethylether, benzoinethylether, benzoinisopropylether, benzoinisobutylether, benzoin benzoic acid, benzoin methyl benzoate, benzoin dimethylketal, 2,4-diethyl thioxanthone, 1-hydroxy cyclohexylphenylketone, benzyl diphenyl sulfide, tetramethylthiuram monosulfide, azobisisobutyronitrile, 2-chloroanthraquinone, diphenyl(2,4,6-trimethylbenzoyl)phosphine oxide, and bis(2,4,6-trimethylbenzoyl)-phenyl-phosphine oxide.

Examples of the thermal polymerization initiator include hydrogen peroxide, peroxydisulfuric acid salts (e.g., ammonium peroxodisulfate, sodium peroxodisulfate, and potassium peroxodisulfate), azo compounds (e.g., 2,2′-azobis(2-amidinopropane)dihydrochloride, 4,4′-azobis(4-cyanovaleric acid), 2,2′-azobisiosbutyronitrile, and 2,2′-azobis(4-methoxy-2,4-dimethylvaleronitrile)), and organic peroxides (e.g., benzoyl peroxide, lauroyl peroxide, peracetic acid, persuccinic acid, di-t-butyl peroxide, t-butyl hydroperoxide, and cumene hydroperoxide).

One of the polymerization initiators may be used alone, or two or more thereof may be used in combination.

When the polymerization initiator is used for forming a cross-linking structure, a content of the polymerization initiator is preferably in a range from 0.1 parts by mass to 100 parts by mass, more preferably in a range from 1 part by mass to 100 parts by mass, and still more preferably in a range from 1 part by mass to 10 parts by mass, with respect to 100 parts by mass of the energy-ray-curable resin or the thermosetting resin.

The resin layer 3 is not necessarily a layer made from a curable resin composition, and may be, for instance, a layer formed from a thermoplastic resin composition. A thermoplastic resin layer can be softened by containing a solvent in the thermoplastic resin composition. With this configuration, when forming the pseudo sheet structure 2 on the resin layer 3, attachment of the conductive linear bodies 21 to the resin layer 3 is facilitated. The thermoplastic resin layer can be dried to be solidified by volatilizing the solvent in the thermoplastic resin composition.

Examples of the thermoplastic resin include polyethylene, polypropylene, polyvinyl chloride, polystyrene, polyvinyl acetate, polyurethane, polyether, polyethersulfone, polyimide and acrylic resin.

Examples of the solvent include an alcohol solvent, ketone solvent, ester solvent, ether solvent, hydrocarbon solvent, alkyl halide solvent, and water.

The resin layer 3 may contain an inorganic filler. The resin layer 3 containing the inorganic filler can have a further improved hardness after cured. In addition, the resin layer 3 containing the inorganic filler has an improved heat conductivity.

Examples of the inorganic filler include inorganic powder (e.g., powders of silica, alumina, talc, calcium carbonate, titanium white, colcothar, silicon carbide, metal, and boron nitride), beads of spheroidized inorganic powder, single crystal fiber, and glass fiber. Among the above, a silica filler and an alumina filler are preferable as the inorganic filler. One of the inorganic fillers may be used alone, or two or more thereof may be used in combination.

The resin layer 3 may contain other components. Examples of other components include known additives such as an organic solvent, a flame retardant, a tackifier, an ultraviolet absorber, an antioxidant, a preservative, an antifungal agent, a plasticizer, a defoamer, and a wettability modifier.

A thickness of the resin layer 3 is determined as needed depending on an intended use of the wiring sheet 100. For instance, in view of adhesiveness, the thickness of the resin layer 3 is preferably in a range from 3 μm to 150 μm, more preferably in a range from 5 μm to 100 μm.

### Electrodes

The electrodes 4 are used for supplying electric current to the conductive linear bodies 21. The electrodes 4 are in direct contact with the conductive linear bodies 21. The electrodes 4 are disposed at both ends of the conductive linear bodies 21 and electrically connected thereto.

The electrodes 4 are formable using a known electrode material. Examples of the electrode material include a conductive paste (e.g., silver paste), metallic foil (e.g., copper foil), and metal wire. The electrodes 4 are preferably made from a metal wire. When a metal wire is used as the electrodes, both the electrodes and wiring from a power source are metallic lines, facilitating the connection therebetween. In the exemplary embodiment, the contact between the conductive linear bodies 21 and the electrodes 4 is stabilized, restraining an increase in resistance value. Thus, even when a metal wire or the like is used instead of a conductive paste or metallic foil excellent in contact resistance, the contact resistance between the conductive linear bodies 21 and the electrodes 4 can be stabilized.

When the electrode material is a metal wire, the metal wire may be a single wire, preferably provided by two or more wires. Further, as shown in FIG. 1, four metal wires may be used. The number of metal wires used for one of the electrodes may be different from that used for the other of the electrodes. The metal wires are preferably wavy-shaped in a plan view of the wiring sheet 100. Examples of the wavy shape for the metal wires include a sine wave, rectangular wave, triangular wave, and saw-tooth wave. The electrodes 4 with such an arrangement are not likely to be broken when the wiring sheet 100 is stretched in the axial direction of the electrodes 4.

Examples of metal of the metallic foil or metal wire include metals such as copper, aluminum, tungsten, iron, molybdenum, nickel, titanium, silver, and gold and alloys containing two or more metals (e.g., steels such as stainless steel and carbon steel, brass, phosphor bronze, zirconium-copper alloy, beryllium copper, iron nickel, Nichrome®, nickel titanium, KANTHAL®, HASTELLOY®, and rhenium tungsten). The metallic foil or metal wire may be plated with tin, zinc, silver, nickel, chromium, nickel-chromium alloy, solder, or the like. Especially, metal containing at least one selected from copper, silver, and an alloy containing copper and/or silver is preferable in view of metal having a low volume resistivity.

The width of one of the electrodes 4, in a plan view of the pseudo sheet structure 2, is preferably 3,000 μm or less, more preferably 2,000 μm or less, and still more preferably 1,500 μm or less. When two or more metal wires are used as the electrode, the width of the electrode 4 refers to a sum of the widths of the respective metal wires. A plurality of metal wires may be in direct contact with each other or electrically connected via the conductive linear bodies 21. When the electrode 4 is provided by a single metal wire, the width of the electrode 4 is a diameter of the metal wire.

A ratio in resistance value between the electrodes 4 and the pseudo sheet structure 2, which is obtained by a formula “a resistance value of the electrodes 4/a resistance value of the pseudo sheet structure 2”, is preferably in a range from 0.0001 to 0.3, more preferably in a range from 0.0005 to 0.1. When the wiring sheet 100 is used as a heat-generating body, the pseudo sheet structure 2 to be heated needs to have resistance to some extent. On the other hand, preferably, electric current easily flows in the electrodes 4 as much as possible. This causes a difference in resistance value between the electrodes 4 and the pseudo sheet structure 2. For the above reason, temperature unevenness is more likely to occur as the ratio in resistance value between the electrodes 4 and the pseudo sheet structure 2 is larger.

The resistance values of the electrodes 4 and the pseudo sheet structure 2 can be measured using a tester. First, the resistance value of the electrodes 4 is measured and the resistance value of the pseudo sheet structure 2 attached with the electrodes 4 is measured. Subsequently, the respective resistance values of the electrodes 4 and the pseudo sheet structure 2 are calculated by subtracting the measurement value of the electrodes 4 from the resistance value of the pseudo sheet structure 2 attached with the electrodes. Further, the resistance values can be measured by taking the electrodes 4 out of the wiring sheet 100, as needed.

### Contact Fixing Members

The contact fixing member 5, which is a contact point between the conductive linear body 21 and the electrode 4, fixes the conductive linear body 21 and the electrode 4. The contact fixing members 5 stably provide the electrical connection between the electrodes 4 and the pseudo sheet structure 2, stabilizing the resistance value of wirings. As shown in FIG. 1, it is preferable that the contact fixing members 5 are each independently arranged in a cross-sectional view of the wiring sheet 100. In such an arrangement, the contact fixing members 5 do not interfere with the stretching of the wiring sheet 100 when the wiring sheet 100 stretches in the axial direction of the electrodes 4. Accordingly, the stretchability of the wiring sheet 100 in the axial direction of the electrodes 4 can be provided. Moreover, the stretchability in the axial direction of the conductive linear bodies 21 is further improvable.

When a plurality of metal wires are used for each electrode 4 as described above, the contact fixing members 5 may be provided for the respective contacts between the respective metal wires forming the electrode 4 and the conductive linear bodies 21. Such an arrangement further improves the stretchability of the wiring sheet 100.

The wording of each independently arranged refers to an arrangement in which the contact fixing members are provided for the respective contacts between the respective metal wires forming the electrode 4 and the conductive linear bodies 21 or an arrangement as shown in FIG. 1 in which each of the contact fixing members is provided for the corresponding one of units. Each unit is formed by a plurality of nearby contacts.

The contact fixing member 5 is preferably at least one selected from the group consisting of a metal, adhesive agent, and crimping.

The metal is exemplified by solder. When using solder, the conductive linear bodies 21 can be joined to the electrodes 4 by soldering. As a solder alloy, any known solder alloy is usable. For instance, a lead-free solder containing tin, silver, and copper is usable.

As the adhesive agent, the adhesive agent used in the resin layer 3 is usable. The adhesive agent may be a conductive adhesive agent. The adhesive agent is preferably a curable adhesive agent, because the curable adhesive agent allows the conductive linear bodies 2 and the electrodes 4 to be firmly fixed. Examples of the curable adhesive agent include a thermosetting adhesive agent that is curable by heat and an energy-ray-curable adhesive agent. Examples of the energy ray include an ultraviolet ray, visible energy ray, infrared ray, and electron ray. It should be noted that “curing with an energy ray” includes thermosetting by energy-ray heating.

As the crimping, the contact fixing member 5 can be provided by performing crimping at the contact between the conductive linear body 21 and the electrode 4.

An elastic modulus at 25 degrees C. of the contact fixing member 5 is preferably 5.0×10⁸ Pa or more. At an elastic modulus of 5.0×10⁸ Pa or more, the resistance value of wirings can be more reliably stabilized. Further, from the above viewpoint, the elastic modulus at 25 degrees C. of the contact fixing member 5 is more preferably 8.0×10⁹ Pa or more, still more preferably in a range from 1.0×10⁹ Pa to 1.0×10¹¹ Pa.

### Method of Producing Wiring Sheet

A method of producing the wiring sheet 100 according to the exemplary embodiment is not specifically limited. The wiring sheet 100 can be produced, for instance, by a process described below.

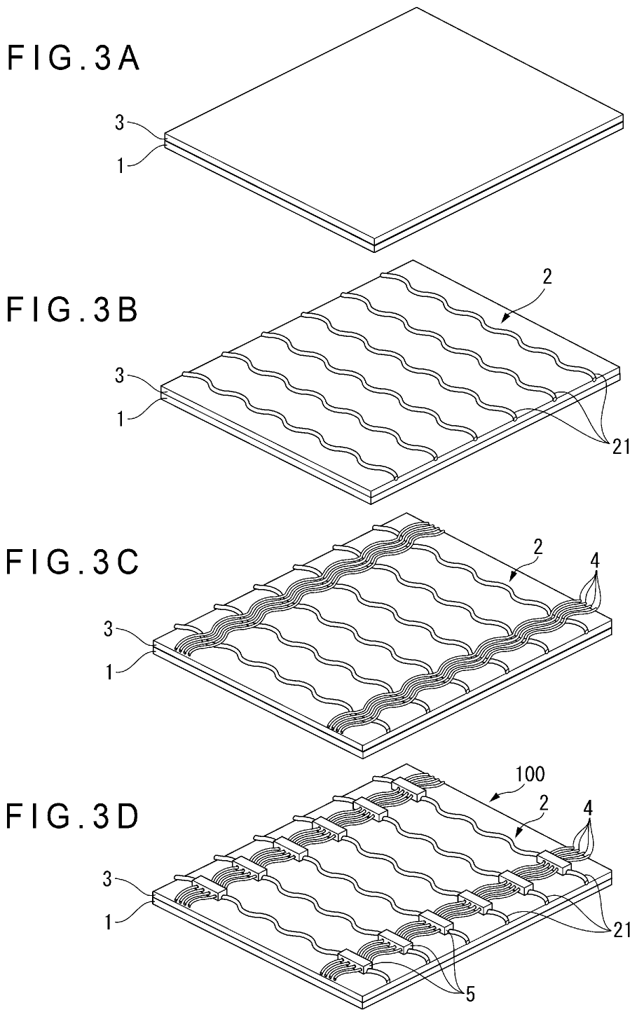

First, as shown in FIG. 3A, the base material 1 is coated with an adhesive agent for forming the resin layer 3 to form a coating film. Subsequently, the coating film is dried to form the resin layer 3. Then, as shown in FIG. 3B, the conductive linear bodies 21 are arrayed on the resin layer 3 to form the pseudo sheet structure 2. For instance, a drum member is rotated while the resin layer 3 attached with the base material 1 is disposed on an outer circumferential surface of the drum member, and the conductive linear bodies 21 are spirally wound on the resin layer 3 during the rotation of the drum member. After that, a bundle of the conductive linear bodies 21 spirally wound is cut along an axial direction of the drum member, resulting in the pseudo sheet structure 2 arranged on the resin layer 3. The resin layer 3 attached with the base material 1, on which the pseudo sheet structure 2 is formed, is taken off the drum member, thereby obtaining a sheet-shaped conductive member. According to this method, the interval L between adjacent ones of the conductive linear bodies 21 of the pseudo sheet structure 2 is easily adjusted by, for instance, moving a feeder of the conductive linear bodies 21 along a direction parallel with an axis of the drum member while rotating the drum member.

Next, as shown in FIG. 3C, the electrodes 4 are attached to respective ends of the conductive linear bodies 21 of the pseudo sheet structure 2 of the sheet-shaped conductive member. Then, as shown in FIG. 3D, the contact fixing members 5 are provided at contacts between the conductive linear bodies 21 and the electrodes 4. The contact fixing members 5 can be provided, for instance, by forming a coating film of a curable adhesive agent at contacts between the conductive linear bodies 21 and the electrodes 4 and curing the curable adhesive agent. The wiring sheet 100 is thus produced.

### Advantages of First Exemplary Embodiment

The following advantages can be achieved by the exemplary embodiment.
(1) According to the exemplary embodiment, the conductive linear bodies 21 and the electrodes 4 are fixed by the contact fixing members 5, making it possible to prevent the electrodes 4 from separating from the pseudo sheet structure 2. Further, the electrical connection between the electrodes 4 and the pseudo sheet structure 2 is stably provided, stabilizing the resistance value of wirings.
(2) According to the exemplary embodiment, the contact fixing members 5 are each independently arranged in a cross-sectional view of the wiring sheet 100. Thus, when the wiring sheet 100 stretches in the axial direction of the electrodes 4, the contact fixing members 5 do not interfere with the stretching of the wiring sheet 100. Accordingly, the stretchability of the wiring sheet 100 in the axial direction of the electrodes 4 can be provided. Moreover, the stretchability in the axial direction of the conductive linear bodies 21 is further improvable.
(3) According to the exemplary embodiment, the conductive linear bodies 21 and the electrodes 4 are wavy-shaped in a plan view of the wiring sheet 100. In such an arrangement, the conductive linear bodies 21 are not likely to be broken when the wiring sheet 100 is stretched in the axial direction of the conductive linear bodies 21. Further, the electrodes 4 are not likely to be broken when the wiring sheet 100 is stretched in the axial direction of the electrodes 4.
(4) According to the exemplary embodiment, the base material 1 and the resin layer 3 have stretchability. This improves bearing properties of the wiring sheet 100, resulting in the wiring sheet 100 with better stretchability.

### Second Exemplary Embodiment

Next, a second exemplary embodiment of the invention will be described below with reference to the attached drawings. The scope of the invention is not limited to the disclosure of the exemplary embodiment. It should be noted that some parts of the drawings are enlarged or reduced in size for the convenience of description.

The second exemplary embodiment is different from the first exemplary embodiment in that contact fixing members 5A are in a form of a solidified product of a molten resin of the base material 1.

In the following, differences from the first exemplary embodiment are mainly described and duplicate explanations are omitted or simplified. Components that are the same as those of the first exemplary embodiment are designated by the same codes, and any explanation therefor is omitted or simplified.

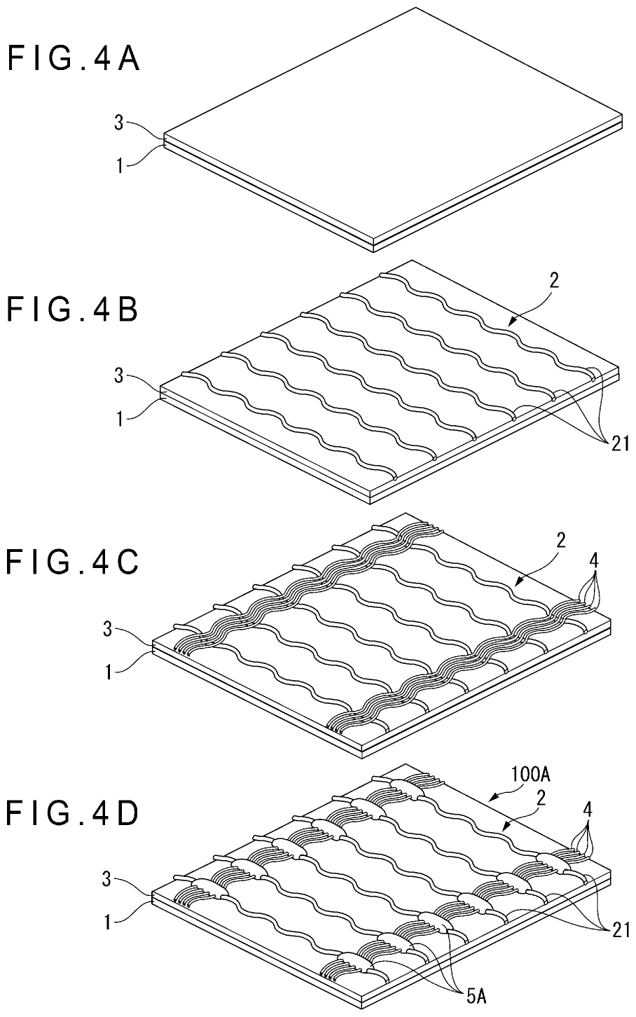

As shown in FIG. 4D, a wiring sheet 100A according to the exemplary embodiment includes the base material 1, the pseudo sheet structure 2, the resin layer 3, and the pair of electrodes 4. The pseudo sheet structure 2 is electrically connected to the electrodes 4. The conductive linear bodies 21 and the electrodes 4 are fixed by contact fixing members 5A at respective connection portions. The contact fixing members 5A are in a form of a solidified product of a molten resin of the base material 1.

### Method of Producing Wiring Sheet

A method of producing the wiring sheet 100A according to the exemplary embodiment is the same as the method of producing the wiring sheet 100 according to the first exemplary embodiment except that the contact fixing members 5A are formed from a molten resin of the base material 1.

First, as shown in FIG. 4A, the base material 1 is coated with an adhesive agent for forming the resin layer 3 to form a coating film. Subsequently, the coating film is dried to form the resin layer 3. Then, as shown in FIG. 4B, the conductive linear bodies 21 are arrayed on the resin layer 3 to form the pseudo sheet structure 2. Next, as shown in FIG. 4C, the electrodes 4 are attached to respective ends of the conductive linear bodies 21 of the pseudo sheet structure 2 of the sheet-shaped conductive member.

In the exemplary embodiment, the base material 1 is preferably at least one selected from the group consisting of a synthetic resin film, nonwoven fabric, and fabric, because a resin forming the base material 1 is meltable. The material of a synthetic resin ora fiber forming fabric is exemplified by polyethylene, polypropylene, polybutene, polybutadiene, polymethylpentene, polyvinyl chloride, vinyl chloride copolymer, polyethylene terephthalate, polyethylene naphthalate, polybutylene terephthalate, polyurethane, ethylene vinyl acetate copolymer, ionomer resin, ethylene-(meth)acrylate copolymer, ethylene-(meth)acrylate ester copolymer, polystyrene, and polycarbonate. The material of a synthetic resin or a fiber forming fabric preferably has an elastic modulus at 25 degrees C. of 5.0×10⁸ Pa or more.

Then, as shown in FIG. 4D, the contact fixing members 5A are provided at contacts between the conductive linear bodies 21 and the electrodes 4. The contact fixing members 5A can be formed by melting and solidifying the resin forming the base material 1. More specifically, the contact fixing members 5A can be formed by at least one method selected from the group consisting of hot press, high-frequency welding, hot-air welding, hot-plate welding, and ultrasonic welding. Among the above, the ultrasonic welding capable of melting the resin in a short time is preferable.

As described above, the wiring sheet 100A is produced.

### Advantages of Second Exemplary Embodiment

According to the second exemplary embodiment, it is possible to have an advantage (5) below in addition to advantages that are the same as the advantages (1) to (4) in the first exemplary embodiment.
(5) In the exemplary embodiment, the contact fixing members 5A can be formed by melting and solidifying the resin forming the base material 1. The contact fixing members 5A can be easily formed without any adhesive agent or solder.

### Modifications of Exemplary Embodiment(s)

The scope of the invention is not limited to the above exemplary embodiments, and modifications, improvements, etc. are included within the scope of the invention as long as they are compatible with an object of the invention.

For instance, the wiring sheet 100 includes the base material 1 in the above exemplary embodiments. The invention, however, is not limited thereto. As an example, the wiring sheet 100 may not include the base material 1. In such a case, the wiring sheet 100 is usable by being attached to an adherend through the resin layer 3.

The wiring sheet 100 includes the resin layer 3 in the above exemplary embodiments. The invention, however, is not limited thereto. As an example, the wiring sheet 100 may not include the resin layer 3. In such a case, a knitted fabric may be used as the base material 1 and the pseudo sheet structure 2 may be formed by weaving the conductive linear bodies 21 into the base material 1.

Further, in the second exemplary embodiment, the contact fixing members 5A are formed by melting and solidifying the resin forming the base material 1. The invention, however, is not limited thereto. As an example, the contact fixing members 5A may be formed by melting the base material 1 and the resin layer 3 and solidifying a mixture thereof, or by melting and solidifying the resin layer 3.

### EXAMPLES

The invention will be described in further detail with reference to Examples. The invention is by no means limited to the Examples.

### Preparation Example 1

An adhesive agent was obtained as follows: 100 parts by mass of an acrylic copolymer (acrylic copolymer having a constituent unit derived from material monomers of n-butylacrylate (BA)/acrylic acid (AAc)=90.0/10.0 (mass ratio), a weight average molecular weight (Mw): 410 thousand) was blended with 0.74 parts by mass (solid content ratio) of an aluminum chelate cross-linking agent (produced by Soken Chemical Co., Ltd., product name “M-5A”, solid content concentration: 4.95% by mass) as a cross-linker and toluene as a diluting solvent.

### Preparation Example 2

A curable adhesive agent was obtained as follows: 100 parts by mass of a phenoxy resin (produced by Mitsubishi Chemical Corporation, trade name “YX7200B35”) was blended with 170 parts by mass of a polyfunctional epoxy compound (produced by Mitsubishi Chemical Corporation, trade name “YX8000”), 0.2 parts by mass of a silane coupling agent (produced by Shin-Etsu Chemical Co., Ltd., trade name “KBM-4803”), 2 parts by mass of a cationic thermal polymerization initiator (produced by SANSHIN CHEMICAL INDUSTRY CO., LTD., product name “SAN-AID SI-B3”), and 2 parts by mass of a cationic thermal polymerization initiator (produced by SANSHIN CHEMICAL INDUSTRY CO., LTD., product name “ SAN-AID SI-B7”).

### Example 1

### Production of Sheet-Shaped Conductive Member

A release film (produced by LINTEC Corporation, trade name “SP-381130”) was coated with the adhesive agent obtained in Preparation Example 1 and dried, thus forming a resin layer of which thickness after drying was 22 μm. A base material in a form of a thermal bond nonwoven fabric made of polyester (weight per unit area: 40 g/m²) was attached to the formed resin layer, obtaining an adhesive sheet.

As conductive linear bodies, a gold-plated tungsten wire (25 μm in diameter, produced by TOKUSAI TungMoly Co., LTD., product name “Au(0.1)-TWG”, hereinafter referred to as “wire”) was prepared. Next, the release film (produced by LINTEC Corporation, trade name “SP-381130”) was released from the adhesive sheet, and the adhesive sheet was creaselessly wound on a drum member having a rubber outer circumferential surface with a surface of the resin layer facing outward. Both ends in a circumferential direction of the adhesive sheet were fixed with a double-sided tape. The conductive linear bodies were spirally wound on the resin layer with the drum member being rotated. The drum member rotated while moving to and fro in a drum axis direction, making the wound wire wavy-shaped. Ten wires were provided at regular intervals of 20 mm. After that, a bundle of the conductive linear bodies spirally wound was cut along the axial direction of the drum member, resulting in the pseudo sheet structure arranged on the resin layer. The adhesive sheet with the pseudo sheet structure was taken off the drum member, obtaining a sheet-shaped conductive member. The sheet-shaped conductive member was cut into a square of 300 mm×300 mm.

### Formation of Electrodes

As electrodes, a gold-plated copper wire (150 μm in diameter, produced by TOKUSAI TungMoly Co., LTD., product name “C1100-H AuP”) was prepared. Next, the sheet-shaped conductive member of 300 mm×300 mm was creaselessly wound on a drum member having a rubber outer circumferential surface with the conductive linear bodies in the sheet-shaped conductive member being parallel with the drum. Both ends in the circumferential direction of the adhesive sheet were fixed with a double-sided tape. The gold-plated copper wire around a bobbin was attached to the surface of the resin layer, and then the gold-plated copper wire was unwound from the bobbin and wound by the drum member. The drum member was gradually moved in a direction parallel to a drum axis, so that the gold-plated copper wire was wound around the drum member spirally at regular intervals. The drum member rotated while moving to and fro in the drum axis direction, making the wound gold-plated copper wire wavy-shaped. Accordingly, an electrode sheet structure, in which gold-plated copper wires were arranged on a surface of the adhesive sheet at regular intervals of 2.5 mm, was formed. Subsequently, similarly, from a position at a length of 200 mm from the inner gold-plated copper wire, the gold-plated copper wire was attached to the surface of the adhesive agent layer, and then the gold-plated copper wire was unwound and wound by the drum member. The drum member was gradually moved in the direction parallel to the drum axis, so that the gold-plated copper wire was wound around the drum member spirally at regular intervals. Accordingly, a sheet-shaped conductive member with electrodes, in which a pair of electrode sheet structures including the gold-plated copper wires arranged at regular intervals of 2.5 mm was formed on the adhesive sheet at a 200 mm distance, was produced. Subsequently, the sheet-shaped conductive member with electrodes was cut along the drum axis. The sheet-shaped conductive member with electrodes was cut into a rectangle of 200 m×250 mm.

### Formation of Contact Fixing Members

A release film (produced by LINTEC Corporation, trade name “SP-382150”) was coated with the curable adhesive agent obtained in Preparation Example 2 and dried, thus forming a curable adhesive agent layer of which thickness after drying was 50 μm. A release film (produced by LINTEC Corporation, trade name “SP-PET381130”) was attached to the curable adhesive agent layer formed, obtaining a laminate. Two sheets of the laminate were formed. The release films (produced by LINTEC Corporation, trade name “SP-PET381130”) were released from the respective laminates, and surfaces of the curable adhesive agent layers adhered to each other. A 100-μm-thick curable adhesive agent layer was thus formed. This curable adhesive agent layer was cut into a piece of 7 mm×10 mm, and one of the release films (produced by LINTEC Corporation, trade name “SP-382150”) was released from the curable adhesive agent layer. The curable adhesive agent layer was placed on each contact point between the conductive linear body and the gold- plated copper wires in the sheet-shaped conductive member with electrodes. After being placed on the contact point, the remaining release film (produced by LINTEC Corporation, trade name “SP-PET381130”) was released. A base material in a form of a thermal bond nonwoven fabric made of polyester (weight per unit area: 40 g/m²) was attached to each surface with the curable adhesive agent layer, producing a wiring sheet.

After that, a vacuum laminator (produced by Nikko-Materials Co., Ltd., product name “V130”) was used to apply pressure of 0.5 MPa at a temperature of 110 degrees C. for 50 minutes, curing the curable adhesive agent layers. The contact fixing members were thus produced.

### Example 2

A wiring sheet was produced in the same manner as in Example 1 except that, when forming the contact fixing members, a solder paste (produced by Harima Chemicals Group, Inc., trade name “PS48BR-600-LSP”) was applied instead of forming the curable adhesive agent layer, and the conductive linear bodies and the gold-plated copper wires in the sheet-shaped conductive member with electrodes were joined at the contact points by heating at 240 degrees C. The composition of the solder alloy used for soldering was Sn-3.2Ag-0.5Cu-4.0Bi-3.5Sb—Ni—Co. This solder alloy has an elastic modulus of 53 GPa.

### Resistance Value Evaluation

A voltage of 3.0 V was applied to the wiring sheet using a DC power supply to determine a resistance value from a current value. After that, the wiring sheet was stored for 250 hours under moist heat conditions where the temperature was 85 degrees C. and the humidity was 85%, and the resistance value was determined similarly above. The change in resistance value (unit: %) before and after storage was determined from a formula below. Table 1 shows the results.

Change in Resistance Value=[(Resistance Value after Storage−Resistance Value before Storage)/Resistance Value before Storage]×100(%)

### Elastic Modulus Measurement

For the contact fixing members produced in Examples, the elastic modulus (GPa) at a temperature of 25 degrees C. was measured using a micro hardness tester (produced by Shimadzu Corporation, Dynamic Ultra Micro Hardness Tester W201S). Table 1 shows the results.

### Stretchability Evaluation

The wiring sheets in Examples were each set in a tensile tester (produced by Shimadzu Corporation, product name “Autograph AG-IS500N”). In the setting, electrode portions were gripping margins and the distance between chucks was 200 mm. The tensile test was performed at a rate of 10 mm/min, measuring stretchability in the axis direction of the conductive linear bodies and stretchability in the axis direction of the electrodes. The resistance value between the pair of electrodes was measured by a digital multimeter, and in a case where the resistance value varied by 10%, the wiring sheet was evaluated as broken. The wiring sheet stretched by 15% or more before breaking was evaluated as “O”, and the wiring sheet broken at stretchability of less than 15% was evaluated as “X”. Table 1 shows the results.

TABLE 1

| | Resistance | | Stretchability Evaluation | |
|---|---|---|---|---|
| | Value | Elastic | Axial Direction of | |
| | Evaluation | Modulus | Conductive Linear | Axial Direction |
| | (%) | (GPa) | Bodies | of Electrodes |
| Ex. 1 | 0.1 | 4.3 | ◯ | ◯ |
| Ex. 2 | 0.2 | 53 | ◯ | ◯ |

### Example 3

A wiring sheet was produced in the same manner as in Example 1 except that, when forming the contact fixing members, the conductive linear bodies and the gold-plated copper wires in the sheet-shaped conductive member with electrodes were joined at the contact points by melting and solidifying the base material using an ultrasonic welding device, instead of providing the curable adhesive agent layer. Conditions for the ultrasonic welding were as follows: welding portion: 8×8 mm; oscillation frequency: 39 kHz; pressure: 0.5 MPa; application time: 0.5 seconds.

Further, the resistance value evaluation and elastic modulus measurement as described above were performed on the obtained wiring sheet. The resistance value evaluation was 0.2%, and the elastic modulus was 0.67 Pa.

1. A wiring sheet, comprising:
a pseudo sheet structure comprising a plurality of conductive linear bodies arranged at intervals; and
a pair of electrodes, wherein
the pseudo sheet structure is electrically connected to the electrodes, and
the conductive linear bodies and the electrodes are fixed with contact fixing members.

2. The wiring sheet according to claim 1, wherein
the contact fixing members are each independently arranged in a cross-sectional view of the wiring sheet.

3. The wiring sheet according to claim 1, wherein
the electrodes are a metal wire.

4. The wiring sheet according to claim 1, wherein
the contact fixing members are at least one selected from the group consisting of a metal, an adhesive agent, and crimping.

5. The wiring sheet according to claim 1, wherein
an elastic modulus at 25 degrees C. of the contact fixing members is 5.0×10⁸ Pa or more.

6. The wiring sheet according to claim 1, wherein
the conductive linear bodies and the electrodes are wavy-shaped in a plan view of the wiring sheet.

7. The wiring sheet according to claim 1, further comprising a stretchable resin layer that supports the pseudo sheet structure.

8. The wiring sheet according to claim 1, further comprising a stretchable base material that supports the pseudo sheet structure.

9. The wiring sheet according to claim 8, wherein
the contact fixing members are at least in a form of a solidified product of a molten resin of the base material.

10. A method of producing the wiring sheet according to claim 9, wherein
the contact fixing members are formed by at least one method selected from the group consisting of hot press, high-frequency welding, hot-air welding, hot-plate welding, and ultrasonic welding.
